(19) United States
(12) Patent Application Publication
(10) Pub. No.: US 2021/0061616 A1
(43) Pub. Date: Mar. 4, 2021

(54) LOW OVERHEAD COMPENSATORY MEASURE

(71) Applicant: Otis Elevator Company, Farmington, CT (US)

(72) Inventors: Aurelien Fauconnet, Isdes (FR); Pascal Rebillard, Gien (FR); Elmar Knauf, Köln (DE)

(21) Appl. No.: 16/832,219

(22) Filed: Mar. 27, 2020

(30) Foreign Application Priority Data
Aug. 27, 2019 (EP) 19315104.0

(51) Int. Cl. B66B 11/02; B66B 9/00; B66B 5/00

(52) U.S. Cl. CPC B66B 11/0246; B66B 5/0087; B66B 5/0062; B66B 9/00

(57) ABSTRACT

An elevator car (1) comprises a working platform (4) moveable between a stowed position, at an upper part (3) of the elevator car (1), and an operational position, suspended from the upper part (3) of the elevator car (1) to be inside the elevator car (1). At least one stop (6a, 6b) is located at the upper part (3) of the elevator car (1). The at least one stop (6a, 6b) is moveable between a retracted position and a deployed position. In the deployed position, the at least one stop (6a, 6b) extends away from the upper part (3) of the elevator car (1) to provide an upper safety space (53) above the elevator car (1).

### FOREIGN PRIORITY

This application claims priority to European Patent Application No. 19315104.0, filed Aug. 27, 2019, and all the benefits accruing therefrom under 35 U.S.C. § 119, the contents of which in its entirety are herein incorporated by reference.

### TECHNICAL FIELD

This disclosure relates to an elevator car with a working platform used to carry out maintenance from inside an elevator car, and in particular to measures to ensure a sufficient safety space for workers on the working platform.

### BACKGROUND

It is known to create a safety space above an elevator car by placing props within the pit of an elevator hoistway, below a counterweight travel path, such that movement of the counterweight below a certain height is prevented, and thus movement of an elevator car, to which the counterweight is connected, above a certain height is prevented. This provides a certain safety space in the overhead of the elevator hoistway. However, it is generally desirable to reduce the overhead in elevator systems so that building space is optimised.

It is also known to provide working platforms located in or above the ceiling of elevator cars, which are moveable between a stowed position and a deployed position. In the deployed position, the working platform is located within the car, at such a height that a maintenance person is able to stand on the working platform and access elevator components inside the hoistway through an opening in the elevator car ceiling. The safety of workers on such a working platform must be ensured at all times.

### SUMMARY

According to a first aspect of this disclosure, there is provided an elevator car comprising: a working platform moveable between a stowed position, at an upper part of the elevator car, and an operational position, suspended from the upper part of the elevator car to be inside the elevator car; at least one stop located at the upper part of the elevator car, wherein the at least one stop is moveable between a retracted position and a deployed position, and wherein, in the deployed position, the at least one stop extends away from the upper part of the elevator car to provide an upper safety space above the elevator car.

According to a second aspect of this disclosure, there is provided a method of

of creating a safety space above an elevator car, the elevator car comprising: a working platform moveable between a stowed position, at an upper part of the elevator car, and an operational position, suspended from the upper part of the elevator car to be inside the elevator car; the method comprising: attaching at least one stop at the upper part of the elevator car, such that the stop is moveable between a retracted position and a deployed position; wherein, in the deployed position, the at least one stop extends away from the upper part of the elevator car to provide an upper safety space above the elevator car.

According to a third aspect of this disclosure, there is provided a method of employing a safety space above an elevator car, the elevator car comprising a working platform moveable between a stowed position, at an upper part of the elevator car, and an operational position, suspended from the upper part of the elevator car to be inside the elevator car; and at least one stop located at the upper part of the elevator car; the method comprising: moving the working platform to the operational position inside the elevator car; standing on the working platform, so as to protrude through the upper part of the elevator car; and manually operating the at least one stop to move the at least one stop from a retracted position to a deployed position, in which the at least one stop extends away from the upper part of the elevator car to provide an upper safety space above the elevator car.

In at least some examples, such a method may further comprise: locking the at least one stop in the deployed position using a locking mechanism.

It will be appreciated that the at least one stop can be deployed to create a safety space above the car when a maintenance person is stood on the working platform.

In at least some examples, in addition or alternatively, the at least one stop lies transversely across the upper part of the elevator car in the retracted position. In at least some examples, the at least one stop lies diagonally across the upper part of the elevator car in the retracted position. A choice may be made about whether to accommodate the at least one stop transversely or diagonally depending e.g. on the length of the stop(s). In some examples, a longer stop may help to meet safety code requirements for the upper safety space above the elevator car. A stop can be made longer in a diagonal arrangement as compared to a transverse arrangement. This may avoid the at least one stop extending horizontally beyond the footprint of the elevator car, and/or reduce the height above of the elevator car of any attachment for the at least one stop, thereby saving spacing in one or more dimensions of the hoistway.

In at least some examples, in addition or alternatively, the at least one stop comprises a first stop and a second stop located at opposed sides of the upper part of the elevator car. By providing a pair of stops, forces on the elevator car are more balanced in the event that the stops engage against a ceiling of the hoistway when deployed. Furthermore, providing a second stop ensures redundancy in the event that the first stop fails to deploy or due to buckling of one stop.

In a first set of examples, the first and second stops lie transversely across the upper part of the elevator car in the retracted position, and extend away from the upper part of the elevator car substantially offset from one another in the deployed position. In such examples, optionally the first stop is located towards the front of the upper part of the elevator car and the second stop is located towards the rear of the upper part of the elevator car. Since the first and second stops are offset from one another, this helps to ensure that the stops do not interfere with one another, particularly when in the retracted position. Both the first and second stops can lie across the upper part of the elevator car in the same plane, minimising the overhead space required.

In a second set of examples, the first and second stops lie diagonally across the upper part of the elevator car in the retracted position, and extend away from the upper part of the elevator car substantially opposite one another in the deployed position. Again, both the first and second stops can lie across the upper part of the elevator car in the same plane, minimising the overhead space required. Furthermore, when the first and second stops extend opposite to each other, there is neither a risk of creating a torque when hitting the top of the hoistway nor is there a risk of creating an imbalance in weight of the elevator car.

As mentioned above, the stops can potentially be made longer when they lie diagonally. In the case of a stop which lies transversely in the retracted position, if a stop is required which is longer than the width of the car (i.e. if placed transversely it would extend horizontally beyond the footprint of the car) then either the stop must be extended further beyond the car footprint, which would then require a wider hoistway, or, as described below, a mounting bracket could be made to extend higher above the car, thus requiring a taller hoistway. A diagonal arrangement allows for the stop(s) to be made longer, without necessarily requiring further space (either as additional width or height) in the hoistway to accommodate the longer stop. This may be exploited even in examples having a single stop.

In at least some examples, in addition or alternatively, the at least one stop is hinged to move between the retracted position and the deployed position. For example, the at least one stop may be hinged around a point which is above the upper part of the elevator car.

In at least some examples, in addition or alternatively, in the retracted position, the at least one stop extends horizontally beyond the footprint of the elevator car. As mentioned above, this may depend on the length of the at least one stop and whether the at least one stop lies transversely or diagonally across the upper part of the elevator car in the retracted position.

In at least some examples, in addition or alternatively, the elevator car further comprises at least one upright, wherein the at least one stop is attached to the at least one upright. In such examples, the elevator car may further comprise a mounting bracket arranged to connect the stop to the upright. In some examples, the mounting bracket may provide a hinged connection between the at least one stop and the upright. In some examples, the mounting bracket may provide a mating connection between the at least one stop and the upright. For example, a mating connection may allow the at least one stop to be received in a correspondingly shaped recess in the upright.

In at least some examples, in addition or alternatively, the at least one stop is configured to be manually operated to move between the retracted position and the deployed position.

In at least some examples, in addition or alternatively, the elevator car further comprises a locking mechanism arranged to lock the at least one stop in the deployed position. In some examples, the locking mechanism comprises a locking pin. For example, the locking pin may be configured such that, when the at least one stop is in the deployed position, the locking pin is moveable to a locking position. The locking pin may be manually or automatically moveable to the locking position. In some examples, the locking mechanism comprises a spring arranged to bias the locking pin into the locking position. In the locking position, the pin may intersect the at least one stop to hold the at least one stop in the deployed position.

In at least some examples, in addition or alternatively, the at least one stop further comprises a buffer portion, at the distal end of the stop. The buffer portion may be formed of any suitable resilient, e.g. elastomeric material, such as rubber.

In at least some examples, in addition or alternatively, the elevator car further comprises a roof frame located at the upper part of the elevator car, wherein the working platform sits within the roof frame in the stowed position to define the roof of the elevator car. Optionally, the working platform is suspended from the roof frame. The roof frame may therefore act as a support frame for the working platform. It will be appreciated that it is standard practice for an elevator car to be completely enclosed by walls, floor and a roof.

In at least some examples, in the deployed position, the at least one stop extends substantially perpendicular to the roof frame. This can help to ensure that the at least one stop is stable in the deployed position.

In at least some examples, in addition or alternatively, in the retracted position, the at least one stop lies substantially parallel to the roof frame. This can ensure that the at least one stop does not take up unnecessary space above the elevator car when not in use.

There is also disclosed herein an elevator system comprising an elevator car according to any of the disclosed examples, and a drive mechanism arranged to drive the elevator car up and down in a hoistway.

### DRAWING DESCRIPTION

Certain preferred examples of this disclosure will now be described, by way of example only, and with reference to the accompanying drawings, in which:

FIGS. 1a, 1b and 1c are cutaway perspective views of an elevator car including a working platform, moveable between a stowed position (as shown in FIG. 1a) and an operational position (as shown in FIG. 1c), according to an example of the present disclosure;

FIG. 2a shows a cutaway perspective view of the upper part of the elevator car of FIG. 1c;

FIG. 2b shows a cutaway perspective view of the upper part of an elevator car according to an alternative example of the present disclosure;

FIG. 3a shows a view from above of the top of an elevator car according to an example of the present disclosure, with the stops in the retracted position;

FIG. 3b shows a view from above of the top of an elevator car according to an example of the present disclosure, with the stops in the deployed position;

FIG. 3c shows a view from above of the top of an elevator car according to an alternative example of the present disclosure, with the stops in the retracted position;

FIG. 3d shows a view from above of the top of an elevator car according to an alternative example of the present disclosure, with the stops in the deployed position;

FIG. 4a shows a cutaway perspective view of the elevator car of FIG. 3b, with the stops in the deployed position;

FIG. 4b shows a cutaway perspective view of the elevator car of FIG. 3d, with the stops in the deployed position;

FIGS. 5a, 5b and 5c are cutaway views, from different perspectives, of an elevator car including stops in the deployed position, and showing the safety space which is created in and above the elevator car according to examples of the present disclosure;

FIGS. 6a and 6b schematically illustrate an exemplary locking mechanism for a stop, acting to lock the stop in the deployed position; and

FIGS. 7a and 7b schematically illustrate the exemplary locking mechanism being unlocked when the stop is in the retracted position.

### DETAILED DESCRIPTION

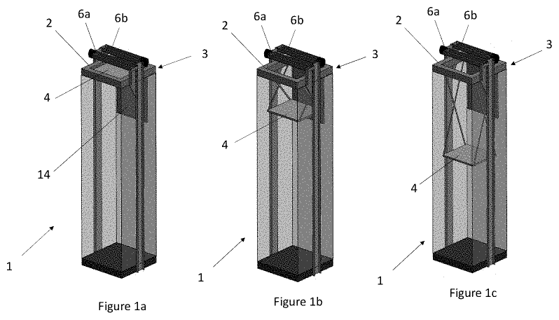

FIG. 1a shows an example of an elevator car 1 including a roof frame 2 located at the upper part 3 of the elevator car 1. Within the roof frame 2 is located a working platform 4, in its stowed position, to form the roof of the elevator car 1. When in this stowed position, a decorative ceiling panel 14 can be placed beneath the bottom of the working platform 4, so that the decorative ceiling panel 14 will partially or fully obscure the working platform 4 from the view of a passenger located within the elevator car 1. FIG. 1a shows the decorative ceiling panel 14 as having been hinged open to reveal the working platform 4, and hanging down towards a wall of the elevator car 1, however, in other embodiments the decorative ceiling panel 14 may simply be removed entirely from its position covering the working platform 4 and placed elsewhere.

Once the decorative ceiling panel 14 has been hinged, or moved, out of the way, the working platform 4 can be removed from the stowed position and moved downwards into the elevator car 1, as is shown in FIG. 1b, and ultimately into the operational position suspended from the roof frame 2 and hanging down inside the elevator car 1, as shown in FIG. 1c. Of course, the working platform may instead be suspended from the walls or attached to any other suitable part of the elevator car 1.

In the operational position, a maintenance person may stand on the working platform 4, such that, when stood fully upright, a portion of the top part of the maintenance person's body will protrude through the opening in the roof frame 2, into the hoistway. From this position the maintenance person can access many of the elevator system components which are located within the elevator hoistway, and thus perform essential maintenance.

It is important to ensure that the maintenance person is protected when carrying out maintenance in an elevator system. In order to ensure this, safety regulations such as EN81-20 have been introduced. In particular, it is required that a maintenance person be provided with a certain minimum “safety space” in which to work, which is a protected space within the elevator hoistway which a maintenance person can access to perform maintenance, and into which elevator components are prevented from travelling. There exist systems in the prior art in which a maintenance person stands on the top of the elevator car to carry out maintenance work. In these systems it is known to include stops or props within the hoistway pit, to prevent downwards movement of the counterweight below a certain height, and thus prevent the elevator car from ascending beyond a certain height. In this way a safety space is created above the elevator car in which a maintenance person may safely work.

The safety regulations specify two different safety space allowances. If a refuge, or safety space, has horizontal dimensions of at least 0.5 m×0.7 m, then it is sufficient to provide a maintenance person with a safety space of a height of 1 m, in which they can crouch. In an elevator car 1 of the type described above, including a working platform 4 which is moved down into the elevator car 1, if the horizontal footprint of the elevator car is sufficiently large then the safety space will only need to be 1 m tall. This is generally less than the distance from the working platform 4 in the operational position to the roof frame 2 at the top of the elevator car, and hence the space within the elevator car 1 will be sufficient to provide the necessary safety space.

However, if the elevator car 1 has small horizontal dimensions, smaller than 0.5 m×0.7 m, as is sometimes desirable, then a so-called “type 1”, or upright, safety space is required. In this case, minimum horizontal dimensions of 0.4 m×0.5 m must be provided in the safety space, but also the protected space must now be sufficiently tall to allow a maintenance person to safely stand upright in the safety space and be protected. In this case, the space within the elevator car 1, above the working platform 4, and below the roof frame 2, is usually not sufficient, as a minimum height of 2 m is required for the safety space.

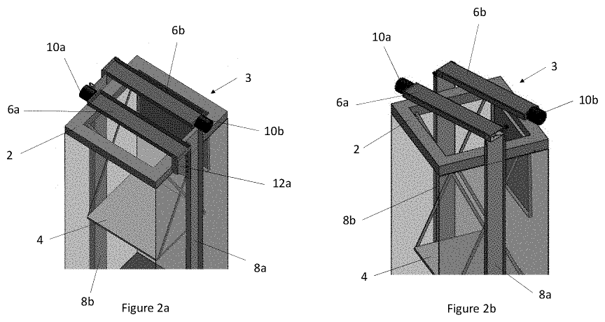

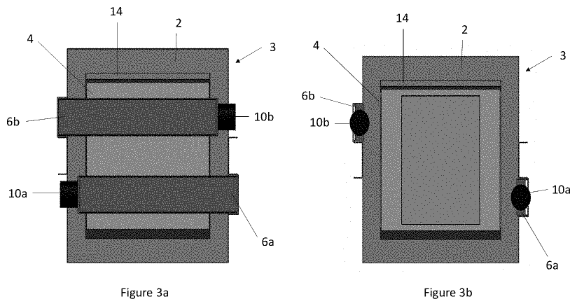

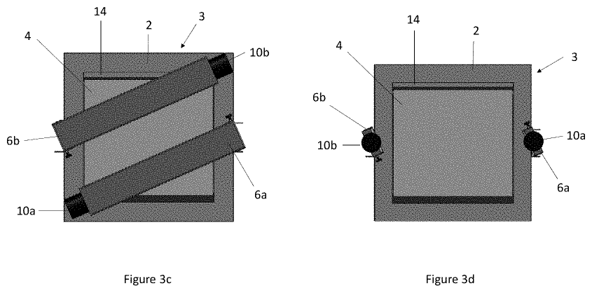

In order to overcome this issue, and create a sufficiently large safety space, at least one stop 6a is provided above the elevator car 1. In some preferred examples illustrated herein, the elevator car 1 comprises a first stop 6a and a second stop 6b. The elevator car 1, and in particular the first stop 6a and the second stop 6b, are shown in more detail, in the retracted position, in FIG. 2a and FIG. 3a. An alternative arrangement for the first and second stops 6a, 6b in the retracted position is shown in FIG. 2b and FIG. 3b. Description is given below of certain features which first stop 6a may optionally have. It will be understood by the skilled person that second stop 6b, and any other additional stops included in the elevator car 1, may optionally have any of these features, according to examples of the present disclosure.

The stop 6a can be attached to the elevator car 1 in any suitable way. The stop 6a could be attached to the elevator car 1 only in its deployed position, described below, for example one or more such stops 6a could be received in a correspondingly shaped recess to form a mating connection which holds each stop 6a upright in the deployed position. Alternatively, the stop 6a could be attached at all times to the elevator car 1. In some examples, the stop 6a may be attached directly to the roof frame 2. Alternatively, as seen in FIG. 2a, the stop 6a is attached to a mounting bracket 12a in this example. Similarly, the opposite stop 6b is attached to a mounting bracket 12b. There is a hinged connection between the stops 6a, 6b and the mounting brackets 12a, 12b. The mounting brackets 12a, 12b are attached to the car uprights 8a, 8b. The car uprights 8a, 8b are common elevator system components that do not require any further description. In some examples, the stops 6a, 6b are arranged to pivot between the retracted position and the deployed position, as described below. Alternatively, as seen in FIG. 2b, the stops 6a, 6b may be attached directly to the car uprights 8a, 8b. In this example, there is a removable connection between the stops 6a, 6b and the car uprights 8a, 8b, such as a locking pin that can be manually inserted to hold the stops 6a, 6b upright in the deployed position.

In these examples, the stop 6a comprises a buffer portion 10a at the distal end of the stop 6a. Similarly, the stop 6b comprises a buffer portion 10b at the distal end of the stop 6b. The buffer portions 10a, 10b may be formed of rubber or any other resilient material. The distal end of each of the stops 6a, 6b will be understood by the skilled person as the end of the stop 6a, 6b which is furthest from the mounting bracket 12a, 12b, which is also the end furthest from the elevator car 1, when the stop 6a, 6b is in the deployed position.

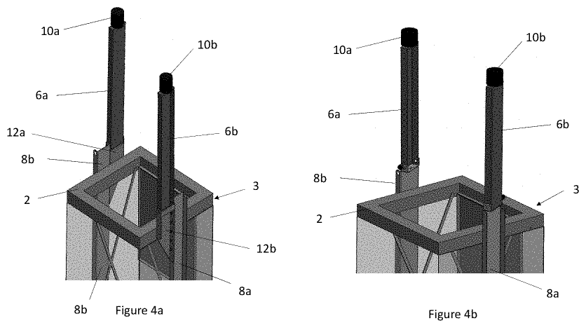

Once a maintenance person has moved the working platform 4 to the operational position, and is stood on the working platform 4, they are then in a position to be able to move the stops 6a, 6b from the retracted position, as shown in FIGS. 2a and 2b and FIGS. 3a and 3c, into the deployed position, as shown in FIGS. 3b and 3d, and FIGS. 4a and 4b. In some examples, the stops 6a, 6b are manually operable to move between the retracted position and the deployed position i.e. moved by hand by a maintenance person.

In the example seen in FIG. 3b and FIG. 4a, and the example seen in FIG. 3d and FIG. 4b, the stops 6a, 6b are in the deployed position, extending away from the upper part 3 of the elevator car 1 to provide an upper safety space above the elevator car 1, in addition to the internal safety space created inside the elevator car 1, from the working platform 4 to the roof e.g. roof frame 2. Together the internal safety space and the upper safety space create a total safety space which is sufficient to meet code requirements. The stops 6a, 6b need not be fully vertical in the deployed position, and could be located at an angle of less than 90 degrees to the horizontal plane as defined by the roof e.g. roof frame 2. However, as illustrated in FIGS. 3b and 3d and FIGS. 4a and 4b, in these examples the stops 6a, 6b are substantially vertical in the deployed position i.e. substantially perpendicular to the horizontal plane as defined by the roof e.g. roof frame 2.

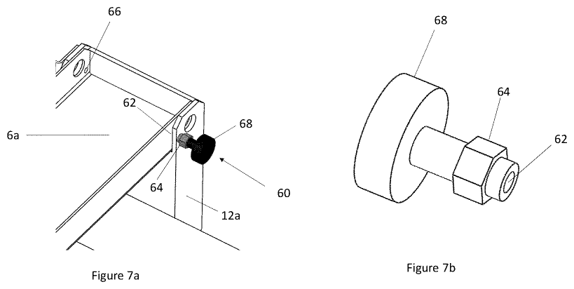

Once the maintenance person has moved the stops 6a, 6b from their retracted position to their deployed position, the stops 6a, 6b can be fixed in the deployed position using a locking mechanism shown in more detail in FIGS. 6a and 6b and FIGS. 7a and 7b, and discussed in more detail below, with reference to these Figures.

In the deployed position, the stops 6a, 6b are arranged to provide an extension of the structural part of the elevator car 1 i.e. an extension of the uprights 8a, 8b, so that if the elevator car 1 were to move, uncontrolled, upwards in the hoistway then the stops 6a, 6b and in particular the buffer portions 10a, 10b will contact the top of the hoistway and prevent further movement, guaranteeing a maintenance person a total safety space sufficient to meet code requirements.

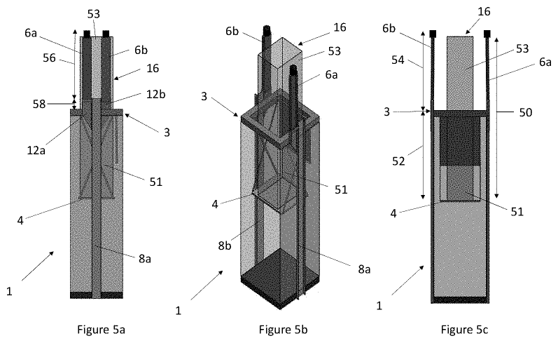

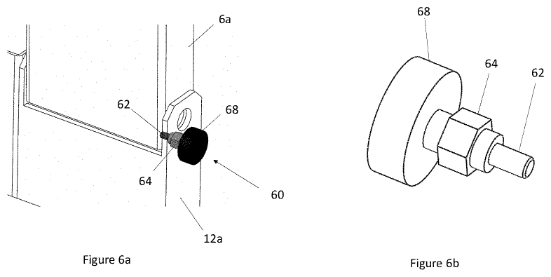

FIG. 5a shows a side view of an elevator car 1 according to an example of the present disclosure, including first stop 6a, and optional second stop 6b, in the deployed position, and showing a total safety space 16 made up of an internal safety space 51, extending from the working platform 4 to the upper part 3 of the elevator car 1, and an upper safety space 53, created above the elevator car 1 by the stops 6a, 6b.

FIG. 5b shows a perspective view of the elevator car 1 of FIG. 5a, including the total safety space 16.

FIG. 5c shows a front view of the elevator car 1 of FIGS. 5a and 5b, including the total safety space 16.

In the example shown in FIGS. 2a, 3a, 3b, 4a, and 5a-5c, the first stop 6a is offset from the second stop 6b, in the front/back direction as defined by the elevator car 1 i.e. the first stop 6a is located further forward on the elevator car 1 than the second stop 6a (or vice versa). The first stop 6a is attached to the upright 8a on the side that is nearer to the front of the elevator car 1 (i.e. nearer to the left in FIG. 5a), whilst the second stop 6b is attached to the upright 8b (not visible in FIG. 5a), on the opposed side of the elevator car 1, and located closer to the rear of the elevator car 1 (i.e. nearer to the right in FIG. 5a).

In some examples, the elevator car 1 is arranged such that each stop 6a, 6b is hinged to fold down from the deployed position to the retracted position, and to lie substantially horizontally above the roof e.g. roof frame 2. If, as an alternative to the offset stop layout described above, each stop 6a, 6b were to be attached at the same distance from the front of the elevator car 1, on opposed side walls, then the stops 6a, 6b would interfere with each other when folded down into the retracted position. One of the stops would have to lie on top of the other stop, which would thus increase the height of the stops in the retracted position and so have the negative effect of increasing the overhead height required for the elevator car 1. The offset stop layout described above is therefore particularly advantageous since the stops 6a, 6b can be folded into a retracted position as shown in FIG. 2a and FIG. 3a, in which each stop 6a, 6b, lies substantially horizontally over separate, different parts of the roof e.g. roof frame 2, such that each stop 6a, 6b can be folded substantially horizontally to its lowest possible height, thus reducing the overhead height required by the stops 6a, 6b in their retracted position to its minimum value.

An alternative to this arrangement is shown in FIGS. 2b, 3c, 3d and 4b. In this example, the stops 6a and 6b are attached to the elevator car in positions which are substantially opposite each other i.e. each stop 6a, 6b is attached at the same distance along the elevator car in the front/back direction, but the stops 6a,6b are arranged to lie diagonally across the upper part 3 of the elevator car. In this example, the stops 6a, 6b are not attached to mounting brackets, but instead attached directly to the car uprights 8a, 8b by any suitable mounting arrangement. As can be seen in FIG. 3d, the stops 6a, 6b can be arranged to remain substantially diagonal to the roof frame 2 in the deployed position. Alternatively, a suitable connection could be used to connect the stops 6a, 6b to the respective uprights 8a, 8b such that, as the stops 6a, 6b are moved from the retracted to the deployed position, the stops 6a, 6b rotate from a diagonal configuration to face each other directly across the roof e.g. as defined by the roof frame 2, i.e. facing in the same direction as the stops 6a, 6b shown in FIG. 3b.

As already mentioned, the stops 6a, 6b may not be attached to the car uprights 8a, 8b in a hinged manner. The stops 6a, 6b could be placed in the diagonal arrangement shown in FIG. 3c, in the retracted position, and then removed from this position and locked in the deployed position shown in FIGS. 3d and 4b. An example of a locking mechanism is described below, in relation to FIGS. 6 and 7.

In some examples, the mounting brackets 12a, 12b (or other mounting arrangement) for the stops 6a, 6b are arranged so that the stops 6a, 6b hinge around the top edge of the roof frame 2. In other examples, the stops 6a, 6b are arranged to hinge about a point which is located above the top of the roof e.g. as defined by the roof frame 2. For example, it can be seen in FIG. 5a, that the mounting brackets 12a, 12b extend to the top of the uprights 8a, 8b, which extend above the top of the elevator car 1, and in particular above the top of the roof e.g. roof frame 2. This additional vertical offset allows the total height created by the stops 6a, 6b to be adjusted for the desired height of the safety space 16.

As laid out above, it is desirable according to safety regulations, that in certain circumstances, a maintenance person is provided with a total safety space 16 of a height of at least 2 metres. This total safety space height of 2 m is indicated in FIG. 5c by the arrow 50. The working platform 4 can sit, in the operational position, at any height within the elevator car 1, as described. In some examples, the operational position of the working platform 4 is between 1-1.1 m below the roof, e.g. as defined by the roof frame 2 in these examples. In some particular examples, the operational position of the working platform 4 is 1.1 m below the roof (e.g. as defined by the roof frame 2 in these examples), as represented by arrow 52. This is thus the height of the internal safety space 51. This is particularly advantageous since it allows a substantial portion of a maintenance person's body to be located within the elevator car 1, whilst also allowing them sufficient reach into the elevator hoistway to carry out maintenance work.

In order to provide the desired total safety space 16, the total extension above the elevator car 1 provided by the stops 6a, 6b must therefore be at least 0.9 m, i.e. the upper safety space 53 created by the stops 6a, 6b must be at least 0.9 m. However, in some cases the width of the elevator car 1 may be less than 0.9 m, for example the width of the elevator car 1 may be 0.8 m or 0.7 m. In such a case, if the stops 6a, 6b hinged directly around the top of the roof frame 2, the stops 6a, 6b would need to be of a length of 0.9 m, and would therefore extend, in the retracted position, far outside of the footprint of the elevator car 1. In order to avoid this, the mounting brackets 12a, 12b extend above the top of the roof frame 2, and the stops 6a, 6b are hinged about the top of the mounting brackets 12a, 12b, so that this offset contributes to the total height of the stop arrangement in the deployed position. The total extension height 54 of the upper safety space 53 of 0.9 m (as seen in FIG. 5c) is thus made up both of the length of the stop 56 and the offset distance 58 between the top of the mounting bracket 12a and the top of the roof frame 2 (as seen in FIG. 5a), which allows the length of the stops 6a, 6b to be reduced. In some examples, the stops 6a, 6b may still extend horizontally beyond the footprint of the elevator car 1, as shown in FIG. 3a.

The diagonal arrangement shown in FIGS. 2b, 3c, 3d and 4b provides an advantageous alternative in which longer stops 6a, 6b can be accommodated without requiring additional space either extending outside of the elevator car footprint, or extending above the elevator car 1. Due to their diagonal arrangement, the stops 6a, 6b do not need to extend beyond the car footprint, as shown in FIG. 3c. Furthermore, since this allows longer stops to be provided, the stops 6a, 6b then do not need to be mounted on mounting brackets, in order to further extend the height of the stops when in the deployed position, but rather, as shown in FIG. 4b, the stops 6a, 6b can be mounted directly to the top of the car uprights 8a, 8b, thus requiring no additional height in the hoistway.

In the illustrated examples, the elevator car 1 includes a roof frame 2 and the working platform 4 is suspended from the roof frame 2. However, the roof frame 2 may be omitted and the working platform 4 may be suspended from the upper part 3 of the elevator car 1 in any suitable way. Whether or not the elevator car 1 includes a roof frame 2, the upper safety space 53 (e.g. as seen in FIGS. 5a-5c) is defined by the one or more stops 6a, 6b when they extend away from the upper part 3 of the elevator car 1 in the deployed position.

FIGS. 6a and 6b show an exemplary locking mechanism 60. FIG. 6a shows a close up view of the locking mechanism 60 in a locking configuration, locking the stop 6a in the deployed position. In this example, the locking mechanism 60, shown in more detail in FIG. 6b, comprises a pin 62, which is moveable to a locking position (as shown in FIGS. 6a and 6b) from a non-locking position (as shown in FIGS. 7a and 7b). The locking mechanism 60 includes an outer portion 64, which the pin 62 passes through, such that the pin 62 can move axially relative to the outer portion 64. The pin 62 includes a grip portion 68, which can be gripped, for example by a maintenance person, and used to pull the pin 62 out of the locking position. The outer portion 64 is fixed to a side of the mounting bracket 12a, on the opposite side to the stop 6a. In this example, the stop 6a is slotted between the two sides of the mounting bracket 12a, adjacent to the internal surfaces of the sides of the mounting bracket 12a, and the outer portion 64 of the locking mechanism 60 is fixed to the exterior surface of one side of the mounting bracket 12a. The outer portion 64 is fixed to the mounting bracket 12a directly over a through-hole (not visible) in the mounting bracket 12a, which is suitably sized so that the pin 62 can pass through the through-hole. The stop 6a similarly includes a through-hole 66, visible in FIG. 7a, which is positioned such that the through-hole 66 aligns with the mounting bracket through-hole when the stop 6a is in the deployed position. In this position the pin 62 can pass through both the through-holes, thus preventing relative movement of the stop 6a with respect to the mounting bracket 12a, and locking the stop 6a in the deployed position. Although FIGS. 6 and 7 only show a locking mechanism 60 on one side of the stop 6a, it will be appreciated that such a locking mechanism 60 may be employed on either side, or both sides, of the stop 6a.

In this example, the locking mechanism 60 includes an internal spring (not visible), which biases the pin 62 into the locking position. As a result of this spring, the pin 62 is constantly pushed towards the locking position, so that, as soon as the through-holes on the mounting bracket 12a and the stop 6a align, the pin 62 is pushed by the spring into the locking position, passing through both of the through-holes. The locking mechanism 60 is thus self-locking and no additional force need be applied by a maintenance person to lock the stop 6a, once it has been moved to the deployed position. This advantageously provides a locking mechanism which is simple to deploy.

The locking mechanism 60 must be unlocked in order to be able to move the stop 6a from the deployed position to the retracted position. The pin 62 is moved out of the locking position by applying a force to the grip portion 68, sufficient to overcome the bias of the internal spring. This force, applied for example by a maintenance person, thus pulls the pin 62 back through the through-hole 66 of the stop 6a, and possibly also through the through-hole of the mounting bracket 12a, while the outer portion 64 stays fixed in position. Once the locking pin 62 is moved to the unlocking position, seen in FIGS. 7a and 7b, the stop 6a can be freely moved back to the retracted position (as shown in FIG. 7a).

Although the stops described herein are particularly advantageous in elevator cars having a small horizontal footprint, it will be understood that they can also be advantageous in systems with a larger horizontal footprint and can provide improved safety also in these systems.

It will be appreciated by those skilled in the art that the disclosure has been illustrated by describing one or more specific examples thereof, but is not limited to these examples; many variations and modifications are possible, within the scope of the accompanying claims.

What is claimed is:

1. An elevator car (1) comprising:
a working platform (4) moveable between a stowed position, at an upper part (3) of the elevator car (1), and an operational position, suspended from the upper part (3) of the elevator car (1) to be inside the elevator car (1);
at least one stop (6a, 6b) located at the upper part (3) of the elevator car (1),
wherein the at least one stop (6a, 6b) is moveable between a retracted position and a deployed position, and wherein, in the deployed position, the at least one stop (6a, 6b) extends away from the upper part (3) of the elevator car (1) to provide an upper safety space (53) above the elevator car (1).

2. An elevator car (1) as claimed in claim 1, wherein the at least one stop (6a, 6b) lies transversely or diagonally across the upper part (3) of the elevator car (1) in the retracted position.

3. An elevator car (1) as claimed in claim 1, wherein the at least one stop (6a, 6b) comprises a first stop (6a) and a second stop (6b) located at opposed sides of the upper part (3) of the elevator car (1).

4. An elevator car (1) as claimed in claim 3, wherein, in the retracted position, the first and second stops (6a,6b) lie transversely across the upper part (3) of the elevator car (1) and, in the deployed position, extend away from the upper part (3) of the elevator car (1) substantially offset from one another.

5. An elevator car (1) as claimed in claim 3, wherein, in the retracted position, the first and second stops (6a,6b) lie diagonally across the upper part (3) of the elevator car (1) and, in the deployed position, extend away from the upper part (3) of the elevator car (1) substantially opposite one another.

6. An elevator car (1) as claimed in claim 1, wherein the at least one stop (6a, 6b) is hinged to move between the retracted position and the deployed position.

7. An elevator car (1) as claimed in claim 6, wherein the at least one stop (6a, 6b) is hinged around a point which is above the upper part (3) of the elevator car.

8. An elevator car (1) according to claim 1, further comprising at least one upright (8a, 8b), wherein the at least one stop (6a, 6b) is attached to the at least one upright (8a, 8b).

9. An elevator car (1) as claimed in claim 1, further comprising a locking mechanism (60) arranged to lock the at least one stop (6a, 6b) in the deployed position.

10. An elevator car (1) according to claim 1, wherein, in the retracted position, the at least one stop (6a, 6b) extends horizontally beyond the footprint of the elevator car (1).

11. An elevator car (1) according to claim 1, further comprising a roof frame (2) located at the upper part (3) of the elevator car (1), wherein the working platform (4) sits within the roof frame (2) in the stowed position to define the roof of the elevator car (1).

12. An elevator car (1) according to claim 11 wherein:
in the deployed position, the at least one stop (6a, 6b) extends substantially perpendicular to the roof frame (2); and/or
in the retracted position, the at least one stop (6a, 6b) lies substantially parallel to the roof frame (2).

13. An elevator system comprising an elevator car (1) according to claim 1, and a drive mechanism arranged to drive the elevator car (1) up and down in a hoistway.

14. A method of creating a safety space (16) above an elevator car (1), the elevator car (1) comprising:
a working platform (4) moveable between a stowed position, at an upper part (3) of the elevator car (1), and an operational position, suspended from the upper part (3) of the elevator car (1) to be inside the elevator car (1);
the method comprising:
attaching at least one stop (6a, 6b) at the upper part (3) of the elevator car (1), such that the stop (6a, 6b) is moveable between a retracted position and a deployed position;
wherein, in the deployed position, the at least one stop (6a, 6b) extends away from the upper part (3) of the elevator car (1) to provide an upper safety space (53) above the elevator car (1).

15. A method of employing a safety space (16) above an elevator car (1), the elevator car (1) comprising:
a working platform (4) moveable between a stowed position, at an upper part (3) of the elevator car (1), and an operational position, suspended from the upper part (3) of the elevator car (1) to be inside the elevator car (1); and
at least one stop (6a, 6b) located at the upper part (3) of the elevator car (1);
the method comprising:
moving the working platform (4) to the operational position inside the elevator car (1);
standing on the working platform (4), so as to protrude through the upper part (3) of the elevator car (1); and
manually operating the at least one stop (6a, 6b) to move the at least one stop (6a, 6b) from a retracted position to a deployed position, in which the at least one stop (6a, 6b) extends away from the upper part (3) of the elevator car (1) to provide an upper safety space (53) above the elevator car (1).
